(19) United States
(12) Patent Application Publication
(10) Pub. No.: US 2007/0159615 A1
(43) Pub. Date: Jul. 12, 2007

(54) Object transfer apparatus, exposure apparatus, object temperature control apparatus, object transfer method, and microdevice manufacturing method

(75) Inventor: Takashi Horiuchi, Kawasaki-shi (JP)

Correspondence Address: OLIFF & BERRIDGE, PLC, P.O. BOX 19928, ALEXANDRIA, VA, 22320, US

(73) Assignee: NIKON CORPORATION, TOKYO (JP)

(21) Appl. No.: 11/646,497

(22) Filed: Dec. 28, 2006

(30) Foreign Application Priority Data
Jan. 12, 2006 (JP) 2006-004379

(51) Int. Cl. G03B 27/58

(52) U.S. Cl. 355/72; 355/75

(57) ABSTRACT

In order to reliably transfer an object whose temperature has been controlled to an appropriate temperature in a state in which the appropriate temperature is maintained, there are provided a slider arm 143 that holds and carries a wafer W, a drive device LM having a movable element to which the slider arm 143 is fixed and that integrally moves with the slider, and a heat sink 147 that is inserted between the movable element and the slider arm 143 and controls the temperature of the slider arm 143 to a predetermined temperature.

### CROSS-REFERENCE TO RELATED APPLICATION

This disclosure is based on Japanese Patent Application 2006-004379 filed on Jan. 12, 2006, and the disclosure thereof is incorporated herein by reference in its entirety.

### BACKGROUND OF THE INVENTION

1. Field of the Invention

This invention relates to object transfer apparatus and methods that transfer an object such as a substrate, exposure apparatus provided with the object transfer apparatus, object temperature control apparatus that control a temperature of an object, and methods of manufacturing micro-devices.

2. Description of Related Art

In a photolithographic process that is one of the steps of manufacturing a semiconductor device, a resist coating apparatus (coater) that coats a photosensitive material (photoresist) on a substrate (object) such as a wafer and a glass plate, an exposure apparatus (stepper) that forms a latent image of a pattern that projects and transfers an image of the pattern of a reticle (mask) to a substrate on which the photosensitive material is coated, a developing apparatus (developer) that develops a latent image formed on the substrate, etc. are used. For the transfer of the substrate between the coater and the exposure apparatus, and between the exposure apparatus and the developer, there are apparatus that perform the transfer of a plurality of substrates as a batch by using a substrate carrier (substrate cassette) that can store a plurality of substrates, or there are apparatus that are used along with a substrate cassette, or independently, and that perform individual transfer of substrates between the exposure apparatus and the coater arranged in the vicinity of the exposure apparatus (so-called “in-line” apparatus).

The substrate coated by resist is stored in a substrate carrier, or is individually transferred to a predetermined carrier position from a resist coater, and is individually transferred to a predetermined transfer position at which the substrate is transferred to an exposure main body portion (substrate stage) from a substrate transfer apparatus provided in the exposure apparatus. The substrate on which exposure processing has been completed is carried to a predetermined carrier position from the exposure main body portion by the substrate transfer apparatus, is stored in the substrate carrier, or is individually transferred to a next developer.

A prealignment mechanism that preliminarily controls a position and a posture of the substrate using an outline reference, and a processing portion such as a cool plate, etc. that controls the substrate to a predetermined temperature, are arranged between the transfer position of the substrate and the exposure main body portion. The substrate transfer apparatus sequentially transfers the substrate between the transfer position, the processing portion, and the exposure main body portion. Various types of substrate transfer apparatus are known. For example, a substrate is carried by an articulated robot from a carrier position onto a cool plate. After the substrate whose temperature has been controlled to a predetermined temperature by the cool plate is prealigned (position measurement by outline measurement of the substrate, and position adjustment), as needed, it is transferred to a position at which the substrate is transferred to the exposure main body portion by a slider arm (load slider) that is linearly driven by a linear motor, etc.

In order to improve exposure accuracy (for example, overlay accuracy), after the temperature of the substrate is entirely controlled to a predetermined temperature (the temperature that matches the ambient temperature at the time of exposure by the exposure main body portion) by a cool plate, the substrate is transferred to a position at which the substrate is transferred to the exposure main body portion by a slider arm, etc. However, within the substrate transfer apparatus, various types of heat generating portions such as a drive portion, a circuit board, etc. are arranged. Because of the heat effects, the temperature is not appropriately controlled at the cool plate, or even if the temperature is appropriately controlled by the cool plate, there are cases that the temperature partially or entirely changes (increases) during transfer by a slider arm. Because of this, there are cases that the temperature of the substrate transferred to the exposure main body portion is not appropriate at the position at which the substrate is transferred to the exposure main body portion, and there are cases that this may suppress improvement of exposure accuracy.

### SUMMARY OF THE INVENTION

This invention reflects on the above-mentioned points. One object of this invention is to reliably transfer an object whose temperature is appropriately controlled in a state in which the appropriate temperature is maintained.

This invention provides an object transfer apparatus provided with a holding member that holds an object, a drive device that has a movable element to which the holding member is fixed and that integrally moves with the holding member, and a holding member temperature controlling device that is provided between the movable element and the holding member, and controls the holding member to a predetermined temperature.

According to this invention, the temperature of the holding member that holds an object is controlled to a predetermined temperature by a holding member temperature controlling device. Thus, by setting the predetermined temperature at an appropriate value in a relationship with a temperature of the object held by the holding member, the temperature of the object can be controlled so as not to be changed during the transfer. Therefore, the object can be transferred in a state in which the temperature of the object is maintained. Other objects of this invention and the structure that achieves these objects will become clear with reference to the following embodiments.

### BRIEF DESCRIPTION OF THE DRAWINGS

FIG. 1 is a front view schematically showing an overall structure of an exposure apparatus according to embodiments of this invention.

FIG. 2 is a front view showing a structure of a wafer carrying device according to embodiments of this invention.

FIG. 3 is a perspective view showing a main portion of a load arm unit of embodiments of this invention.

FIG. 4 is a front view showing a main portion of the load arm unit of embodiments of this invention.

FIG. 5 is a perspective view showing a structure of a cleaning unit of embodiments of this invention.

FIG. 6 is a perspective view showing a structure of the cleaning unit of embodiments of this invention.

FIG. 7 is a perspective view showing a first improved example of embodiments of this invention.

FIG. 8 is a perspective view showing the first improved example of embodiments of this invention.

FIG. 9 is a perspective view showing a second improved example of embodiments of this invention.

FIG. 10 is a perspective view showing a third improved example of embodiments of this invention.

FIG. 11 is a perspective view showing a fourth improved example of embodiments of this invention.

FIG. 12 is a diagram conceptually showing a two-step cooling method in the third and fourth improved examples of embodiments of this invention.

FIG. 13 is a diagram conceptually showing a two-step cooling method in the third and fourth improved examples of embodiments of this invention.

FIG. 14 is a diagram conceptually showing a two-step cooling method in the third or fourth improved examples of embodiments of this invention.

FIG. 15 is a diagram conceptually showing a two-step cooling method in the third and fourth improved examples of embodiments of this invention.

FIG. 16 is a perspective view showing a fifth improved example of embodiments of this invention.

FIG. 17 is a perspective view showing a sixth improved example of embodiments of this invention.

FIG. 18 is a perspective view showing a seventh improved example of embodiments of this invention.

FIG. 19 is a perspective view showing the seventh improved example of embodiments of this invention.

FIG. 20 is a perspective view showing an eighth improved example of embodiments of this invention.

FIG. 21 is a perspective view showing a ninth improved example of embodiments of this invention.

### DETAILED DESCRIPTION OF THE INVENTION

The following explains an exposure system according to embodiments of this invention with reference to drawings. This exposure system is provided with an exposure apparatus (exposure main body portion) that performs exposure processing, a wafer transfer apparatus that transfers a wafer to the exposure apparatus, etc. First, the following explains an overall structure of the exposure apparatus and then explains the wafer transfer apparatus.

[Exposure Apparatus]

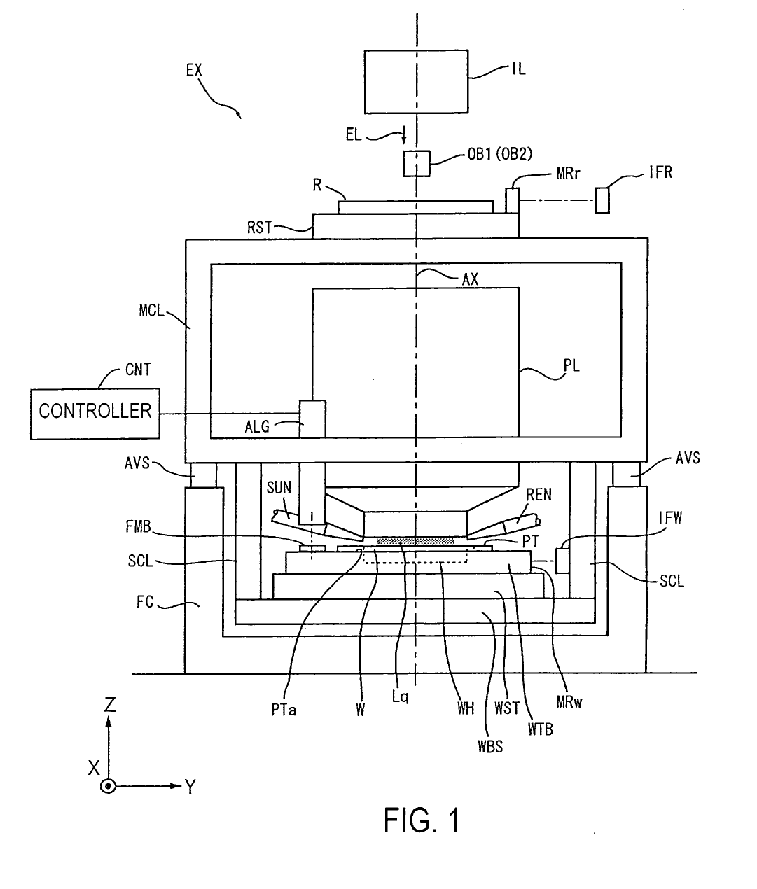

FIG. 1 schematically shows an overall structure of the exposure apparatus. An exposure apparatus EX is a liquid immersion type exposure apparatus and also is a step-and-scan type exposure apparatus that synchronously moves a reticle stage RST and a wafer stage WST with respect to a projection optical system PL, and consecutively transfers an image of a pattern formed on a reticle R to a shot area on a wafer W.

An illumination optical system IL shapes a cross-sectional shape of a laser beam that is emitted from a light source such as an ArF excimer laser light source (wavelength 193 nm) in a slit shape extending in a direction (Y direction) perpendicular to a scan direction (X direction). The irradiation distribution also is made uniform and is emitted as illumination light EL. Furthermore, in this embodiment, an example is used in which an ArF excimer laser light source is provided as a light source. However, an extra-high pressure mercury lamp that emits a g-line (wavelength 436 nm) and an i-line (wavelength 365 nm), or a KrF excimer laser (wavelength 248 nm), an F2 laser (wavelength 157 nm), and other light sources can be used.

The reticle R is adsorbed and held on the reticle stage RST. On one end of the reticle stage RST, a moving mirror MRr is fixed, which is irradiated by a measurement laser beam from a reticle interferometer system IFR. Positioning of the reticle R is performed by a reticle drive device (undepicted) that is micro-rotated within an XY plane as the reticle stage RST is translationally moved within the XY plane perpendicular to an optical axis AX.

When an image of a pattern of the reticle R is transferred onto the wafer W, the reticle drive device scans the reticle stage RST in a predetermined scan direction (X axis direction) at a constant speed. Above the reticle stage RST, alignment systems OB1, OB2 are respectively arranged along the scan direction, which photoelectrically detect a plurality of reticle alignment marks formed in the vicinity of the reticle R. The detection results of the alignment systems OB1, OB2 are used for positioning the reticle R at a predetermined accuracy with respect to the optical axis AX of projection optical system PL, etc. The interferometer system IFR projects a laser beam onto the moving mirror MRr, receives the reflected beam, and measures the position change of the reticle R.

Under the projection optical system PL having a plurality of optical elements such as a lens, etc., a wafer stage WST is arranged, which mounts the wafer W and is two-dimensionally moved along the XY plane. A wafer table WTB is arranged on the wafer stage WST. A wafer holder WH that vacuum-adsorbs the wafer W is arranged on the wafer table WTB.

The wafer table WTB micro-moves and micro-inclines the wafer holder WH in a Z direction (optical axis AX direction), based on a measurement value of an undepicted auto focus mechanism (AF mechanism). A movement coordinate position within the XY plane of the wafer stage WST and a micro-rotational amount by yawing are measured by a wafer interferometer system IFW. This interferometer system IFW irradiates a measurement laser beam from a laser light source (undepicted) onto the moving mirror MRw fixed to the wafer table WTB of the wafer stage WST, causes interference between the reflected light and a predetermined reference light, and measures the coordinate position of the wafer stage WST and the micro-rotational amount (yawing amount). On the wafer table WTB, the outline is formed in a rectangular shape. In the substantially center portion, a water repellent plate PT can be appropriately replacably arranged, in which an aperture (round aperture) PTa of an inner diameter slightly larger than an outer diameter of the wafer W is formed. On the surface of the water repellent plate PT, water repellent processing (water repellent coating) is performed, which uses a fluorocarbon material, etc.

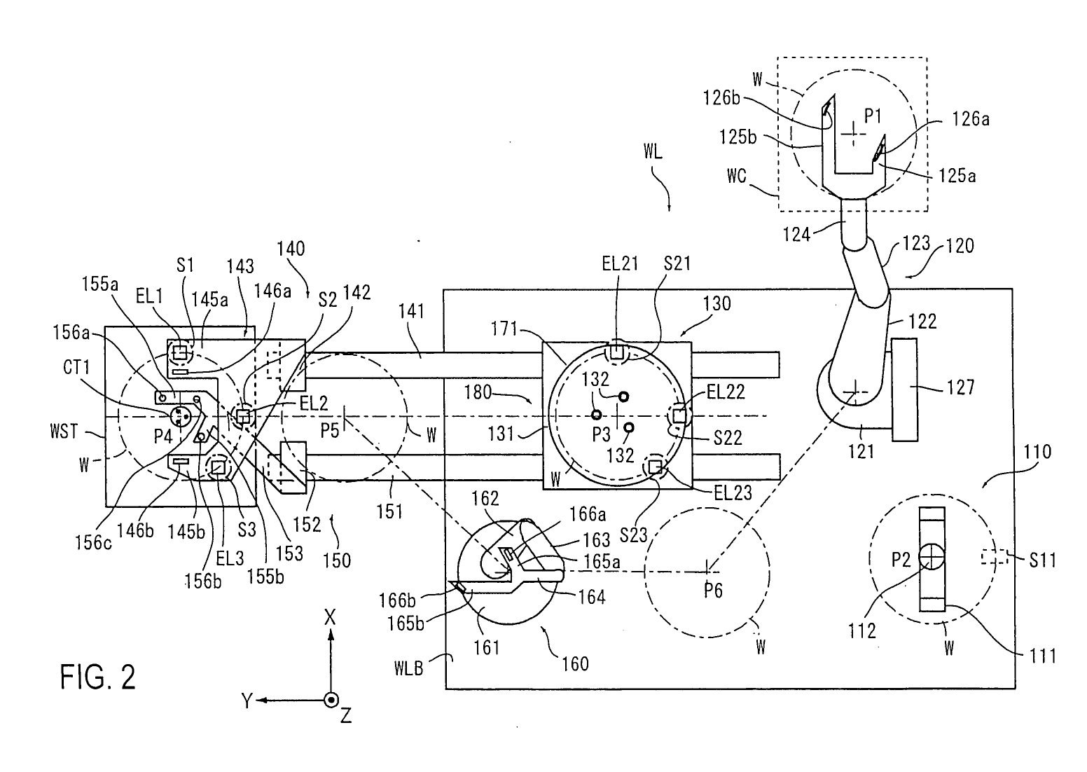

Furthermore, although not depicted in FIG. 1, in the center portion of the wafer holder WH, a center table CT1 (see FIGS. 2 and 4) is arranged, which can be vertically moved in a vertical direction (Z direction). The center table CT1 is a vertically moving mechanism that transfers the wafer W with respect to the wafer stage WST (wafer holder WH). The center table CT1 is constituted such that its tip position can be positioned at an arbitrary position between a top dead center position above the later-mentioned predetermined transfer position and a bottom dead center position below the surface on which the wafer W of the wafer holder is mounted. In the center, an adsorption port is arranged, which vacuum-adsorbs the wafer W.

On the side of the projection optical system PL, an off-axis type alignment sensor ALG is arranged, which measures position information of a wafer mark (alignment mark) formed on the wafer W. As the alignment sensor ALG, in this embodiment, an image processing type FIA (Field Image Alignment) system sensor is used, which irradiates a broadband detecting light, to which the resist on the wafer W is not photosensitive, onto a target mark, images an image of the target mark received on the light receiving surface by the reflected light from the target mark and an image of an undepicted index (index mark on an index plate arranged within the sensor) by an image pick-up element (camera) constituted by a two-dimensional CCD (Charge Coupled Device), etc., and outputs these image pick-up signals. The measurement result by the alignment sensor ALG is supplied to a controller CMT that performs overall control of the exposure apparatus.

Additionally, on the wafer table WTB of the wafer stage WST, a reference plate FMB is mounted, which is used for calibration of an AF sensor provided in the AF mechanism and for measuring a baseline amount, etc. On the surface of the reference plate FMB, along with a mark of the reticle R, a reference mark (fiducial mark) that can be detected by the alignment systems OB1, OB2 and other marks are formed. The AF sensor is a sensor that measures a shift amount of the surface of the wafer W with respect to an image plane of the projection optical system PL. The baseline amount is an amount showing the distance between a reference position (for example, center of a pattern image) of a pattern image of a reticle projected onto the wafer W and a field of view center of the alignment sensor ALG.

The exposure apparatus is a liquid immersion type, so in the vicinity of the tip portion of the image plane side (wafer W side) of the projection optical system PL, a liquid supply nozzle SUN that constitutes a liquid immersion mechanism and a liquid recovery nozzle REN opposite to the SUN are arranged. The liquid supply nozzle SUN is connected to an undepicted liquid supply device via a supply tube. A recovery tube connected to an undepicted liquid recovery device is connected to the liquid recovery nozzle REN. As a liquid, as an example, ultrapure water is used, through which an ArF excimer laser (wavelength 193 nm) is transmitted. An index of refraction n of water with respect to the ArF excimer laser beam is substantially 1.44. In this water, the wavelength of the illumination light (exposure light) EL is shortened to 193 nm X 1/n=approximately 134 nm. The controller CMT approximately controls a liquid supply device, a liquid recovery device and supplies liquid (pure water) from the liquid supply nozzle SUN, and recovers liquid from the liquid recovery nozzle REN. Thus, a constant amount of liquid Lq is held between the projection optical system PL and the wafer W. Furthermore, the liquid Lq is constantly replaced.

The reticle stage RST, the projection optical system PL, the alignment sensor ALG, etc. are supported by a main body column MCL. The main body column MCL is supported, for example, on a frame caster FC arranged on a floor surface of a semiconductor factory via a plurality of (here, three) active isolation tables AVS (only two of these are shown in this figure). The wafer stage WST is supported on a wafer base WBS that is integrally arranged with the main body column MCL via a plurality of support columns SCL. In the main body column MCL, a displacement sensor (undepicted) such as an electric level or an optical inclination angle detector is arranged.

Each active isolation table AVS includes a mechanical damper that can support a large weight such as an air damper, a hydraulic damper, etc., and an electromagnetic damper constituted by an electromagnetic actuator such as a voice coil motor, etc. The electromagnetic dampers in the three active isolation tables AVS are driven so that the inclination angle of the main body column MCL with respect to a horizontal plane, detected by a displacement sensor, is kept within an allowable range, and the air pressure or oil hydraulics, etc. of the mechanical dampers are controlled, as needed. In this case, vibration with a low frequency from the floor is attenuated by the mechanical dampers before it is transmitted to the exposure main body portion. The remaining vibration with a high frequency is attenuated by the electromagnetic dampers.

[Wafer Transfer Apparatus]

FIG. 2 is a plan view showing a structure of a wafer transfer apparatus as an object transfer apparatus according to embodiments of this invention. This wafer transfer apparatus WL is an apparatus that transfers a wafer (object, substrate) W as a transfer subject between a position P2, from which the wafer is transferred to a wafer carrier (wafer cassette) WC that has been transferred to a predetermined FOUP (FOUP: Front Open Unified Pod) position P1, or to a resist coating device (coater) that performs resist coating processing that is a processing step prior to the exposure apparatus, or to a developer that performs development processing that is a processing step following the exposure apparatus, and a predetermined receiving position P4 at which the wafer is transferred to the wafer stage WSD of the exposure apparatus (exposure main body portion) EX.

The wafer transfer apparatus WL is housed within an undepicted wafer loader chamber. On the wafer loader base WLB, the wafer transfer apparatus WL is constituted by arranging a transfer table unit 110, a load robot 120, a cooling unit 130, a load slider 140, an unload slider 150, an unload robot 160, and a water removal unit (undepicted) that removes liquid for liquid immersion exposure that remains on the wafer. A first prealignient portion is arranged in the transfer table unit 110. A second prealignment portion is arranged in the cooling unit 130. A third prealignment portion is arranged in the transfer position P4. Within a wafer loader chamber, gas (here, air) whose temperature is controlled to a predetermined temperature is downwardly supplied through a duct from an air-adjusting device attached to the exposure apparatus EX.

A detailed drawing of the transfer table unit (in-line table) 110 is omitted in the figure. However, the transfer table unit (in-line table) 110 is provided with an upper table and a lower table on which wafers W are respectively mounted. The upper table is a table that receives the wafer W transferred from a resist coater outside of this figure, and the lower table is a table that transfers the wafer W to a developer outside of this figure.

A first prealigument portion is arranged in the transfer table unit 110. In the first prealignment portion, first prealigument is performed, which detects the outline while rotating the wafer W, and roughly measures the center of the wafer W and an azimuth of a notch (or orientation flat). The first prealignment portion is provided with a turntable 112 that can be moved up and down and rotated, and which passes through a throughhole formed in a central portion of the upper table 111 of the transfer table unit 110, and an outline detecting line sensor (line CCD sensor) S11 arranged above the upper table 111.

The load robot 120 is a scalar type articulated robot provided with a first arm 122 of which one end side is rotatably mounted to a robot base 121, a second arm 123 of which one end side is rotatably mounted to the other end side of the first arm 122, and a hand portion 124 of which the base end portion side is rotatably mounted to the other end side of the second arm 123.

The robot base 121 is slidably supported by a Z axis unit 127 in a Z axis direction (vertical direction) and can be positioned in an arbitrary position of a predetermined range in the Z axis direction by a drive portion constituted by a servo motor, a linear encoder, etc. provided by the Z axis unit 127. In the respective connecting portions of the robot base 121, the first arm 122, the second arm 123, and the hand portion 124, drive portions are arranged, which are constituted by a servo motor, a rotary encoder, etc. By controlling these components, the hand portion 124 can be positioned in an arbitrary position at an arbitrary posture.

The hand portion 124 has a pair of finger portions 125a, 125b on the tip side. Adsorption grooves 126a, 126b, which supply a negative pressure that vacuum-adsorbs the wafer W are arranged in the vicinity of the tip portions of the finger portions 125a, 125b, respectively. The finger portions 125a, 125b of the hand portion 124 are constituted non-symmetrically, with respect to the right-to-left direction, so that the finger portion 125b is shorter than the finger portion 125a. A reason why this non-symmetrical structure is used is that the fingers do not interfere with each other when the wafer W is transferred, due to non-symmetry of the finger portions 165a, 165b of the hand portion 164 of the later-mentioned unload robot 160, and the relationship between the posture and progression direction of the hand portions 124, 164 when the wafer W is transferred. The external wall portions of the adsorption grooves 126a, 126b are formed to be slightly high so that the rear surface of the wafer W does not contact the finger portions 125a, 125b when the wafer W is held, and the wafer W is adsorbed and held by vacuum-adsorbing the wafer W via a hole (undepicted) connected to a negative pressure supply tube on the rear side. The adsorption grooves 126a, 126b are formed in an arc shape so that the sides facing each other form a concave shape.

Additionally, in the position P6, a table also can be arranged, which temporarily mounts the wafer. If this is thus constituted, when the exposed wafer W is recovered from the wafer stage WST to the wafer carrier WC via the unload robot 160 and the load robot 120, it is not necessary to directly transfer the wafer from the hand portion 164 of the unload robot 160 to the hand portion 124 of the load robot 120. This is because the unload robot 160 temporarily mounts the wafer W on the table at the position P6, and then the load robot 120 can recover the wafer W from the table. If this table is used, there is an advantage that the structure (particularly, the shape of the finger portions) of the respective hand portions 124, 164 of the respective robots 120, 160 does not have to be the above-mentioned characteristic shape.

In order to improve overlay accuracy (overlay accuracy of a pattern formed in a given layer of the wafer W and a pattern formed thereafter), the cooling unit 130 is a unit that cools (temperature controls) the wafer W to substantially the same temperature as that of the wafer holder WH within the exposure apparatus EX.

The cooling unit 130 is a unit that is provided with a cool plate 131 whose temperature has been controlled, and in which the temperature of the entire surface of the wafer W is controlled to a predetermined temperature by mounting the wafer W on the cool plate 131 for a predetermined time. In order to receive the wafer W, whose temperature should be controlled, from the load robot 120, the cleaning unit 130 is provided with a lift device having three pin members 132 that are radially and equally arranged with respect to the center of the cool plate 131.

At a position P3, the lift device receives the wafer W, which has been transferred to a position above and separated from the cool plate 131, from the load robot 120 by lifting the pin members 132, and mounts the wafer W on the top surface of the cool plate 131 by lowering the pin members 132 after the load robot 120 has retreated. Furthermore, it also is acceptable to make it so that when the wafer is received from the load robot 120 to the pin members 132, the pin members are kept in a raised position, and the load robot 120 is lowered, thus transferring the wafer W from the load robot 120 to the pin members 132.

The wafer W whose temperature has been adjusted by the cool plate 131 is transferred to the later-mentioned slider arm 143 by lifting the pin members 132. Furthermore, in the tip portions of the respective pin members 132, adsorption ports (undepicted) are formed, which vacuum-attract the wafer W.

The second prealignient portion is arranged in the cooling unit 130. Here, second prealignment is performed. Because of this, image pick-up devices S21, S22, S23 constituted by a two-dimensional CCD camera, etc. that images three predetermined locations of the periphery of the wafer W are arranged above the cool plate 131. Furthermore, illumination devices (here, organic EL light emitting bodies) EL 21, EL 22, EL 23 that supply illumination light to the image pick-up devices S21, S22, S23, respectively, are arranged so as to illuminate from below via throughholes formed in the cool plate 131.

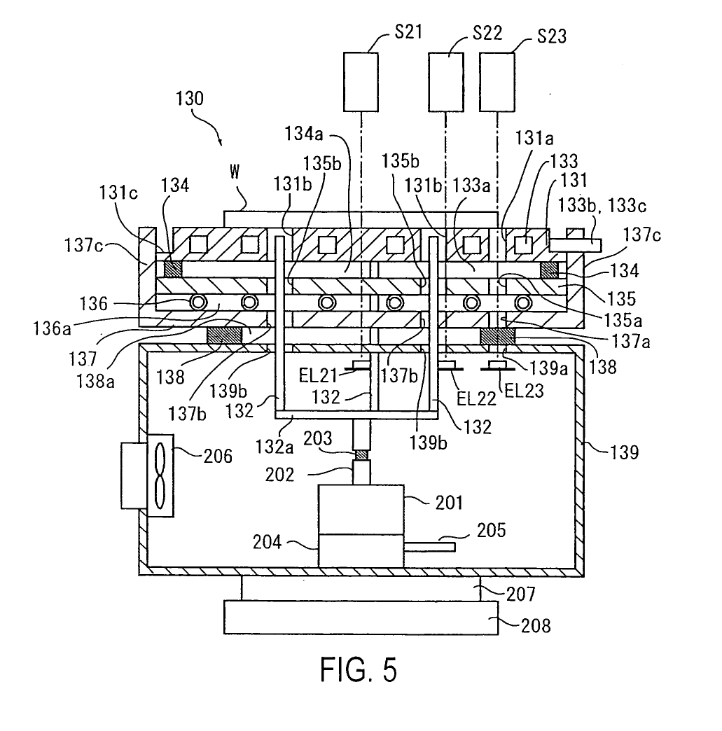

Three locations on the outer circumference of the wafer W positioned at the position P3 are imaged by the image pick-up devices S21, S22, S23, respectively. Based on the image pick-up result (a position error and a rotation error with respect to a predetermined reference), in a micro-adjusting table 207 (see FIG. 5) that entirely supports the cooling unit 130 is driven, micro-rotated, and micro-moved in XY directions. The center position and the rotation position of the wafer W are positioned according to the predetermined reference. Furthermore, a detailed structure of the cooling unit 130 will be discussed later.

The load slider 140 is provided with a slider arm (load slider arm) 143 mounted to a slider 142 that is slidable along a guide 141. The slider arm 143 is reciprocatingly moved between the position P3 at which the cooling unit 130 and the second prealignment portion are arranged and the predetermined position P4 at which the wafer is transferred to the exposure apparatus EX of the wafer stage WST.

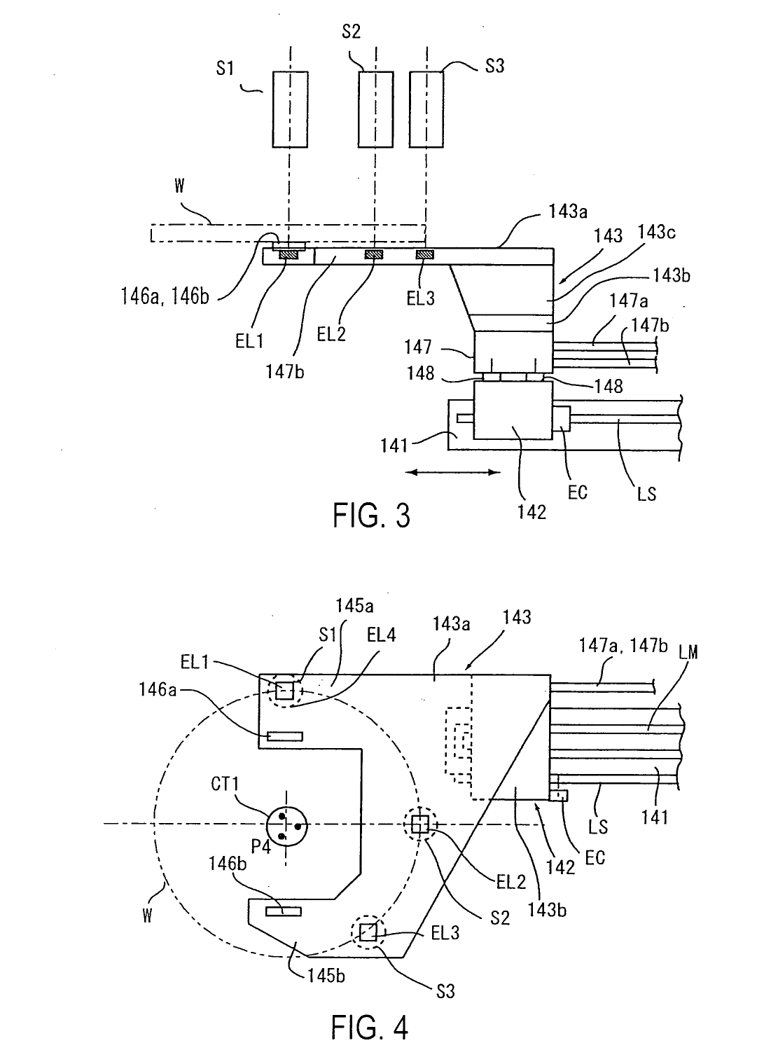

FIGS. 3 and 4 show the detailed structure of the main portion of the load slider 140. The cross section of the guide 141 is formed in a concave shape. In the groove portion inside of the guide 141, a linear motor LM constituted by a stator and a movable element is provided and arranged along the groove portion. The slider 142 is fixed to the movable element of the linear motor LM and is driven by the linear motor LM. The position of the slider 142 is detected by a linear scale LS mounted to the side surface of the guide 141, and an encoder (photosensor) EC mounted to the slider 142, and the slider 142 can be positioned in an arbitrary position along the guide 141.

On the slider 142, a heat sink 147 is arranged, which is supported via a plurality of adiabatic members (for example, adiabatic washers) 148 that are discretely arranged. The slider arm 143 is mounted on the heat sink 147. A member with small heat conductivity, such as ceramic, resin, etc., is used for the adiabatic members 148. In the case of using adiabatic washers, for example, four washers can be arranged to support the four corners of the rectangular top surface of the slider 142. The thickness of the washers is approximately 2-3 mm, the outer diameter is φ 10 mm, and the inner diameter is φ 5 mm. The reason why the plurality of adiabatic members 148 are thus discretely arranged to support the heat sink 147 is to minimize the heat transmitted to the heat sink 147 via the adiabatic members 148 from the slider 142 and to improve the adiabatic effects by forming a gap between the slider 142 and the heat sink 147.

It is preferable that a product with good heat conductivity (raw material with high heat conductivity), such as a ceramic or aluminum, is used for the heat sink 147. Furthermore, the heat sink 147 formed of such a raw material is provided with a passage through which a coolant (for example, pure water, HFE: hydrofluoro ether) is transmitted inside of the heat sink 147.

A supply tube 147a and a recovery tube 147b that supply a coolant to a passage inside of the heat sink 147 are connected to the heat sink 147. As a coolant, in the case of using pure water, it is desirable that a material with high corrosion resistance with respect to water, such as stainless steel (SUS) or a ceramic, should be used to form the heat sink 147. However, if the heat sink 147 is formed of aluminum, if pure water is used as a coolant, a plating process is performed over the internal surface of the coolant passage inside of the heat sink 147, using a metal material, etc. with high corrosion resistance with respect to water. The temperature of the coolant that goes through the heat sink 147 via the supply tubes 147a, 147b, and the recovery tube is set to be the same temperature as the cooling temperature of the wafer W in the cooling unit 130, or is set to be a slightly lower temperature, upon considering the effects of heat from the linear motor LM, etc. Furthermore, the temperature of the coolant that flows is set to be at a constant temperature here. However, the temperature of the wafer W and the temperature of the slider arm during the transfer can be detected, and dynamically changed and controlled.

Furthermore, it also is possible to have a two-or-more-stage structure in which one or more other structures that are the same as the adiabatic members 148 and the heat sink 147, or one or more other adiabatic members and heat sinks of a different structure, are inserted and mounted between the heat sink 147 and the slider arm 143, thereby accomplishing an extremely high adiabatic property. Alternatively, it also is possible to further constitute a Peltier element between the heat sink 147 and the slider arm 143, thereby accomplishing an extremely high adiabatic property. However, if a multi-stage (a plurality of combinations) adiabatic structure is used, the structure may become complex. Thus, the number of stages that should be used for the structure, or what types of combinations should be used for the structure, should be determined depending on the relationship with the temperature change during the transfer by the slider arm 147 of the wafer W.

The slider arm 143 is constituted by integrally forming a hand portion 143a as an upper plate portion that holds the wafer W, a lower plate portion 143b mounted to the heat sink 147, and a side plate portion 143c that mutually connects the hand portion 143a and the lower plate portion 143b in a substantially U shape. The hand portion 143a is provided with a pair of finger portions 145a, 145b. A pair of adsorption grooves 146a, 146b that vacuum-adsorb the wafer W to be transferred is arranged in the finger portions 145a, 145b, respectively. The external wall portions of the adsorption grooves 146a, 146b are formed to be slightly high so that the rear surface of the wafer W does not contact the hand portion 143a when the wafer W is held. By vacuum-attracting the wafer W via an undepicted hole connected to a negative pressure supply tube on the rear surface side, the wafer W is attracted and held.

Three illumination devices EL1, EL2, EL3 are arranged in the hand portion 143a. The respective illumination devices EL1, EL2, EL3 are arranged in concave portions formed in the hand portion 143a and are constituted by organic EL (Electro Luminescence) light emitting bodies. The illumination devices EL1, EL2, EL3 are arranged so as to face three image pick-up devices S1, S2, S3, respectively, constituted by a two-dimensional CCD camera, etc., that are supportedly fixed to the main body column MCL of the exposure apparatus EX in a state in which the hand portion 143a is positioned in the transfer position P4. The illumination light beams from the illumination devices EL1, EL2, EL3 are received by the image pick-up devices S1, S2, S3 supported by the main body column MCL of the exposure apparatus EX, respectively. Thus, three predetermined locations of the periphery of the wafer W held by the hand portion 143a and positioned at the transfer position P4, or the wafer W after it has been transferred to the center table CT1 of the wafer stage WST from the hand portion 143a, can be imaged.

The unload slider 150 is provided with a hand portion 153 mounted to a slider 152 that can be slid along the guide 151. The hand portion 153 is provided with a pair of finger portions 155a, 155b that are non-symmetrically arranged. In the respective finger portions 155a, 155b, adsorption pins 156a, 156b, 156c are arranged, which vacuum-attract the wafer W to be transferred.

The external wall portions of the adsorption pins 156a, 156b, 156c are formed to be slightly high so that the rear surface of the wafer W does not contact the finger portions 155a, 155b when the wafer W is held. By vacuum-attracting the wafer W via an undepicted hole connected to a negative pressure supply tube on the rear surface side, the wafer W is adsorbed and held. The slider 152 is driven by a driver having a linear motor and a linear encoder, etc. that are not depicted. The hand portion 153 is reciprocatingly moved between the position P4 at which the wafer is transferred to the wafer stage WST and a position P5 at which the wafer is transferred to the hand portion 164 of the unload robot 160.

The unload robot 160 is a scalar type articulated robot provided with a first arm 162 in which one end side is rotatably mounted to a robot base 161, a second arm 163 in which the other end side is rotatably mounted to the other end side of the first arm 162, and a hand portion 164 in which the base end portion side is rotatably mounted to the other end side of the second arm 163. In the respective connecting portions of the robot base 161, the first arm 162, the second arm 163, and the hand portion 164, drive portions are arranged, which are constituted by a servo motor, a rotary encoder, etc. By controlling these, the hand portion 164 can be positioned in an arbitrary position at an arbitrary posture.

The hand portion 164 is provided with a pair of finger portions 165a, 165b on the tip sides. In the vicinity of the tip portions of the respective finger portions 165a, 165b, adsorption grooves 166a, 166b are arranged, which supply a negative pressure that vacuum-adsorbs the wafer W. The finger portions 165a, 165b of the hand portion 164 are constituted so as to be non-symmetrical with respect to the right-to-left direction. Here, a shape is provided in which the finger portion 165b is shorter than the finger portion 165a and the longitudinal direction of the finger portion 165a crosses the longitudinal direction of the finger portion 165b. A reason for making the pair of finger portions 165a, 165b have a non-symmetrical structure is that the fingers do not interfere with each other when the wafer W is transferred, due to non-symmetry of the finger portions 125a, 125b in the hand portion 124 of the above-described load robot 120, and the relationship between and the posture and the progressing direction of the hand portions 124, 164 when the wafer W is transferred, and due to non-symmetry of the finger portions 155a, 155b of the hand portion 153 of the unload slider 150, and the relationship between the posture and progression direction of the hand portions 153, 164 when the wafer W is transferred. The external wall portions of the adsorption grooves 166a, 166b are formed to be slightly high so that the rear surface of the wafer W does not contact the finger portions 165a, 165b when the wafer W is held. By vacuum-attracting the wafer W via a hole (undepicted) connected to a negative pressure supply tube on the rear surface side, the wafer W is attracted and held. The adsorption grooves 166a, 166b are linearly formed so as to be parallel to each other.

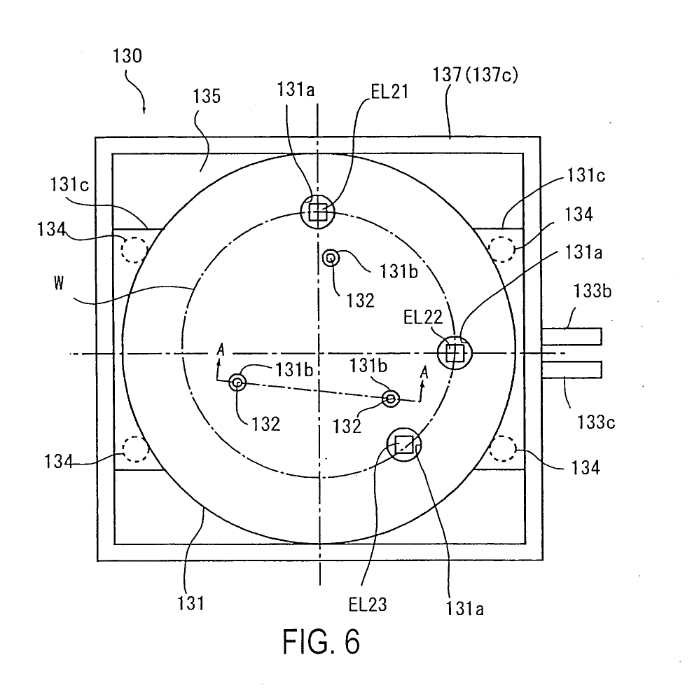

The following explains details of the cooling unit 130 with reference to a perspective view of FIG. 5 and a plan view of FIG. 6. The cool plate 131 that cools the wafer W to be mounted is provided with passages 133 that transmit a coolant (for example, HFE: hydrofluoro ether) through the inside of the cool plate 131. The passages 133 are aligned in a zigzag manner in order to cover the inside of the cool plate 131, and one end is connected to a supply tube 133b that supplies a coolant, and the other end is connected to a recovery tube 133c that recovers a coolant. With respect to the cool plate 133, as an example, the motherboard is formed of aluminum, which has high conductivity and a light weight, and a ceramic is sprayed over the top surface (wafer contact surface) on which the wafer W of the motherboard is mounted.

As a coolant, if pure water is used, as the cool plate 131, it is desirable that a material with high corrosion resistance with respect to water, such as stainless steel (SUS) or ceramic, is used. However, if aluminum is used to form the cool plate 131, if pure water is used as a coolant, a plating process can be performed inside of the coolant passages 133 of the cool plate 131, using a metal material, etc. with high corrosion resistance with respect to water. The temperature of the coolant which flows through the cool plate 131 via the supply tube 133b and the recovery tube 133c is set to be substantially the same temperature as atmospheric temperature at the time of exposing the wafer W in the exposure apparatus EX. Additionally, the temperature of the coolant that has been caused to flow is set to be at a constant temperature here, but it is also acceptable to detect the temperature of the mounted wafer W, and dynamically change and control the temperature of the coolant.

In the cool plate 131, a plurality of (here, three) throughholes 131a that transmit illumination light (detected light) to be emitted by the illumination devices EL21, EL22, EL23 are formed at positions corresponding to the illumination devices EL21, EL22, EL23. Additionally, in the cool plate 131, three throughholes 131b are formed, through which three pin members 132 are respectively inserted. The pin members 132 constitute the center table that lifts the wafer W.

At a flange portion 131 c formed on part of the periphery of the cool plate 131, the cool plate 131 is supported via a plurality of adiabatic members 134 that are discretely arranged on a first adiabatic plate 135. A member with small heat conductivity, such as a ceramic, resin, etc., is used to form the adiabatic members 134. For example, in the case of using adiabatic washers, washers having a thickness of 2-3 mm, an outer diameter of φ 10 mm, and an inner diameter of φ 5 mm may be appropriately arranged at four points on the first adiabatic plate 135. However, three points or five points or more can be used. Reasons why the plurality of adiabatic members 148 are discretely arranged and support the cool plate 131 are to minimize the heat transmitted to the cool plate 131 via the adiabatic members 134 and to improve the adiabatic effect by forming a gap (first gap) 134a between the lower surface of the cool plate 131 and the top surface of the first adiabatic plate 135.

For the first adiabatic plate 135 and the later-mentioned second adiabatic plate 137, a product formed of a raw material with high heat conductivity is used (a highly heat-conductive material, SUS, or resin is acceptable, but preferably, aluminum, ceramic, etc. is used). By using the first and second adiabatic plates 135, 137 formed of a raw material having high heat conductivity, heat outside of the adiabatic plates can be absorbed. Then, the heat absorbed by the adiabatic plates is expelled by a coolant that flows into the later-mentioned pipe arrangement 136. Alternatively, heat can be expelled by air-conditioning gaps (the later-mentioned first gap 134a, second gap 136a, third gap 138a) adjacent to the respective adiabatic plates.

In the first adiabatic plate 135, a plurality of (here, three) throughholes 135a that transmit illumination light emitted from the illumination devices EL21, EL22, EL23 are formed at positions corresponding to the illumination devices EL21, EL22, EL23. Furthermore, in the first adiabatic plate 135, three throughholes 135b are formed, through which are inserted the respective pin members 132 that constitute the center table that lifts the wafer W.

The first adiabatic plate 135 is supported above the second adiabatic plate 137, via a pipe arrangement 136 aligned in a zigzag manner so that its adjacent portions are spaced apart from each other and so that it provides coverage, such that a lower surface side of the first adiabatic plate is above the second adiabatic plate 137. Additionally, the periphery of the first adiabatic plate 135 is supported inside of a sidewall portion 137c that is formed integrally with the periphery of the second adiabatic plate 137. The pipe arrangement 136 is formed of, for example, aluminum, which has high heat conductivity and a light weight. A coolant (for example, HFE; hydrofluoro ether) passes through the inside of the pipe arrangement 136. As a coolant, if pure water is used, as the pipe arrangement 136, it is desirable that the pipe arrangement 136 is formed by using a material with high corrosion resistance with respect to water, such as stainless steel (SUS) or ceramic. However, if the pipe arrangement 136 is formed by using aluminum, if pure water is used as a coolant, a plating process can be performed inside of a coolant passage of the pipe arrangement 136, using a metal material, etc. with high corrosion resistance with respect to water.

The temperature of the coolant that flows through the pipe arrangement 136 is set to be a temperature that substantially matches atmospheric temperature at the time of exposing the wafer W in the exposure apparatus EX. Furthermore, the temperature of the coolant that passes through is set to be at a constant temperature here. However, it is also acceptable to detect the temperature of each part, and dynamical change and control the temperature of the coolant. Thus, reasons why the first adiabatic plate 135 is supported via the pipe arrangement 136 are to minimize the heat transmitted to the first adiabatic plate 135 via the pipe arrangement 136 from the second adiabatic plate 137 and to improve the adiabatic effect by forming a gap (second gap) 136a between the lower surface of the first adiabatic plate 135 and the upper surface of the second adiabatic plate 137.

As explained above, the second adiabatic plate 137 is formed by a raw material with high heat conductivity. In the second adiabatic plate 137, a plurality of (here, three) throughholes 137a that transmit illumination light to be emitted from the illumination devices EL21, EL22, EL23 are formed at positions corresponding to the illumination devices EL21, EL22, EL23. Furthermore, in the second adiabatic plate 137, three throughholes 137b are formed, through which are respectively inserted the pin members 132 that constitute the center table that lifts the wafer W. The sidewall portion 137c of the second adiabatic plate extends to substantially the same height as that of the top surface of the cool plate 131.

The second adiabatic plate 137 is supported via a plurality of adiabatic members 138 that are discretely arranged on the top surface of a drive portion casing 139 that houses a drive portion as a heat generating body inside. As the adiabatic members 138, items similar to the adiabatic members 134 can be used, and in order to support the second adiabatic plate 137, four points can be used, which are appropriately arranged on the top surface of the drive portion casing 139. However, support may also be provided at three points or five points or more. Thus, reasons why the second adiabatic plate 137 is supported by discretely arranging the plurality of adiabatic members 138 are to minimize the heat transmitted to the second adiabatic plate 137 from the top surface of the drive portion casing 139 via the adiabatic members 138 and to improve the adiabatic effects by forming a gap (third gap) 138a between the lower surface of the second adiabatic plate 137 and the top surface of the drive portion casing 139. On an upper plate portion that constitutes the top surface of the drive portion casing 139, a plurality of (here, three) throughholes 139a that transmit illumination light to be emitted from the illumination devices EL21, EL22, EL23 are formed at positions corresponding to the illumination devices EL21, EL22, EL23. Furthermore, on the upper plate portion of the drive portion casing 139, three throughholes 139b are formed, through which are respectively inserted the three pin members 132 that constitute the center table that lifts the wafer W.

Inside of the drive portion casing 139, a drive portion 201 is housed, which vertically moves, on a pin support portion 132a, the three pin members 132 that constitute the center table. The drive portion 201 is provided with a cam mechanism that has a DC motor and an eccentric cam, or the like. An actuating shaft 202 of the drive portion 201 is connected to the lower surface side of the pin support portion 132a.

The drive portion 201 positions and drives the center table to an arbitrary position between a bottom dead center point, at which tips of the pin members 132 are positioned lower than the top surface of the cool plate 131, and a top dead center point, which is positioned higher than the transfer position of the wafer W set above the cool plate 131. Although not depicted in the figure, negative pressure supply tubes are also arranged, which supply a negative pressure to apertures formed in the tip surfaces of the pin members 132 that attract, through negative pressure, the rear surface of the wafer W.

An adiabatic member 203 is mounted between the pin support portion 132a and the actuating shaft 202 of the drive portion 201. As the adiabatic member 203, an item the same as the adiabatic washers can be used. This adiabatic member 203 suppresses the heat of the drive portion 201 from being transmitted to the pin support portion 132a and the pin members 132 via the actuating shaft 202.

In order to suppress the temperature from increasing along with the heat generated by the drive portion 201, the drive portion 201 is arranged on the top surface of a lower plate portion of the drive portion casing 139 via a heat sink 204. Pipe arrangement 205 supplies and recovers a coolant with respect to the heat sink. An item similar to the heat sink 147 that cools the above-mentioned slider arm 143 can be used for the heat sink 204.

Furthermore, inside of the drive portion casing 139, via the throughhole 139a on the top surface of the drive portion casing 139, the throughhole 137a of the second adiabatic plate 137, the throughhole 135a of the first adiabatic plate 135, and the throughhole 131a of the cool plate 131, the illumination devices EL21, EL22, EL23 are correspondingly arranged, which supply illumination light via predetermined locations (here, three locations) of the periphery of the wafer W to the image pick-up devices S21, S22, S23 constituted by a two-dimensional CCD, etc. arranged above the cool plate 131.

In this embodiment, the illumination devices EL21, EL22, EL23 are arranged corresponding to the three image pick-up devices S21, S22, S23. However, in order to correspond to the respective sizes (for example, 12-inch wafer, 8-inch wafer, etc.) of the wafer W, if a plurality of image pick-up devices are additionally arranged, a plurality of illumination devices are additionally arranged accordingly. Furthermore, in this case, the throughholes 131a, 135a, 137a, 139a arranged in the respective members 135, 137, 139 of the cool plate 131, etc. are arranged correspondingly. Furthermore, here, the wafer W is a wafer having a notch (V-shaped cut-in) formed in part of the periphery. However, in the case of a wafer having an orientation flat (cut-in on a straight line), the image pick-up devices S21, S22, S23, the illumination devices EL21, EL22, EL23, and the respective throughholes 131a, 135a, 137a, 139a are placed at corresponding positions, depending on the case (two locations on the orientation flat and one location on the periphery other than these two locations).

At a part of the sidewall of the drive portion casing 139, an exhaust fan 206 is arranged, which discharges gas (air) inside of the drive portion casing 139 to the outside of the casing. When this exhaust fan 206 is driven, gas surrounding the cool plate 131 is introduced from the throughholes 131a, 131b formed in the cool plate 131, and from the gap between the sidewall portion 137c of the second adiabatic plate 137 and the cool plate 131, to the inside of the drive portion casing 139 via the first gap 134a, the throughhole 135a, 135b of the first adiabatic plate 135, the second gap 136a, the throughholes 137a, 137b of the second adiabatic plate 137, the third gap 138a, and the throughholes 139a, 139b of the drive portion casing 139. Along with the heat generated by the drive portion 201, etc. inside of the drive portion casing 139, gas is emitted to the outside of the casing. Thus, the effects of the heat generated by the drive portion 201, etc. does not affect the cool plate 131 (the wafer W to be cooled).

The drive portion casing 139 (that is, the entire cleaning unit 130 mounted thereon) is supported on the micro-adjusting table 207 that micro-adjusts the rotation and the position in the XY direction. The micro-adjusting table 207 is micro-rotated and micro-moved in order to correct a rotation error and a position error with respect to a predetermined reference of the wafer W that is obtained from the imaging result by the second prealignment portion (image pick-up devices S21, S22, S23).

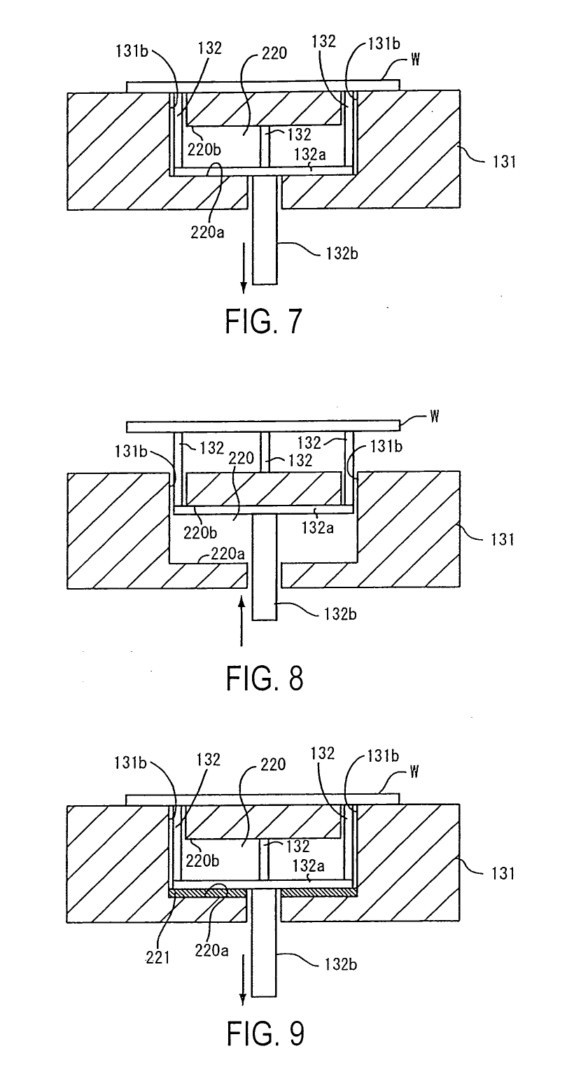

In the center table constituted by the three pin members 132, three throughholes 131b, in which the pin members 132 loosely fit, are formed at three locations of the cool plate 131. Thus, there are cases that the cooling effect of the cool plate 131 does not sufficiently affect the portions of the mounted wafer W that correspond to the throughholes 131b, and there is a concern that a temperature distribution might be generated over the wafer W. A first improved example that improves upon this point is explained with reference to FIGS. 7 and 8. FIGS. 7 and 8 are perspective views (figures corresponding to an A-A cross section of FIG. 6) related to a first improved example of this embodiment. FIG. 7 shows a state in which the center table (pin members 132) is lowered, and FIG. 8 shows a state in which the center table (pin members 132) is lifted. Furthermore, the portions that functionally are substantially the same as in FIGS. 5 and 6 have the same numbers.

In this first improved example, inside of the cool plate 131, an internal space 220 is formed, which is in communication with the throughholes 131b. The pin support member 132a that supports the three pin members 132 is housed inside of this internal space 220. The throughholes 131b are different from those of FIG. 5. They do not extend vertically from the top surface to the bottom surface of the cool plate 131, and are holes that extend from the top surface of the cool plate 131 to the internal space 220 (however, here, these holes are expressed as throughholes for convenience). The pin support member 132a is provided with a support portion 132b in the lower surface center portion. This support portion 132b is driven by a drive portion (undepicted) in the same manner as in the drive portion 201 of FIG. 5, and the pin members 132 are vertically moved. Furthermore, in this improved example, on the top plate portion of the first adiabatic plate 135, the second adiabatic plate 137, and the drive portion casing 139 of FIG. 5, the throughholes 135b, 137b, 139b corresponding to the three pin members 132 are not formed. Instead, a throughhole through which the support member 132b passes is formed at the center portion, respectively. Other structures are substantially the same as in FIG. 5.

As shown in FIG. 7, in a state in which the center table is lowered, the lower surface of the pin support member 132a contacts a lower surface 220a of the internal space 220 of the cool plate 131. Through this contact portion, the pin support member 132a and the respective pin members 132 are cooled. Furthermore, in this state, the tip surfaces of the pin members 132 are on the same plane as the surface of the cool plate 131. The portions of the wafer W mounted on the cool plate 131 corresponding to the throughholes 131b contact the tips of the pin members 132 and are thereby cooled, which suppresses a temperature distribution from being generated over the wafer W.

Meanwhile, when the center table is lifted, as shown in FIG. 8, the top surface of the pin support member 132a contacts the lower surface 220b of the portion of the cool plate 131 positioned above the inner space 220. Through this contact portion, the pin support member 132a and the respective pin members 132 are cooled. Therefore, the center table (the pin members 132) contact the cool plate 131 at the top and bottom dead center points so as to be cooled, so substantially the same temperature as that of the cool plate 131 can be maintained.

Furthermore, as a second improved example of this embodiment, as shown in FIG. 9, on the lower surface 220a of the internal space 220 of the cool plate 131, an elastic member 221 formed of a rubber, etc. with high heat conductivity may also be arranged. Thus, the lower surface of the pin support member 132a contacts the lower surface 220a of the internal space 220 of the cool plate 131 through the elastic member 221, so cooling efficiency can be improved. Furthermore, because of elasticity of the elastic member 221, the tip surfaces of the pin members 132 are on the same plane as the surface of the cool plate 131, and the tip surfaces of the pin members 132 appropriately contact the wafer W. Additionally, although not depicted in the figure, the same elastic member may also be arranged on the lower surface 220b of the portion positioned above the internal space 220 of the cool plate 131.

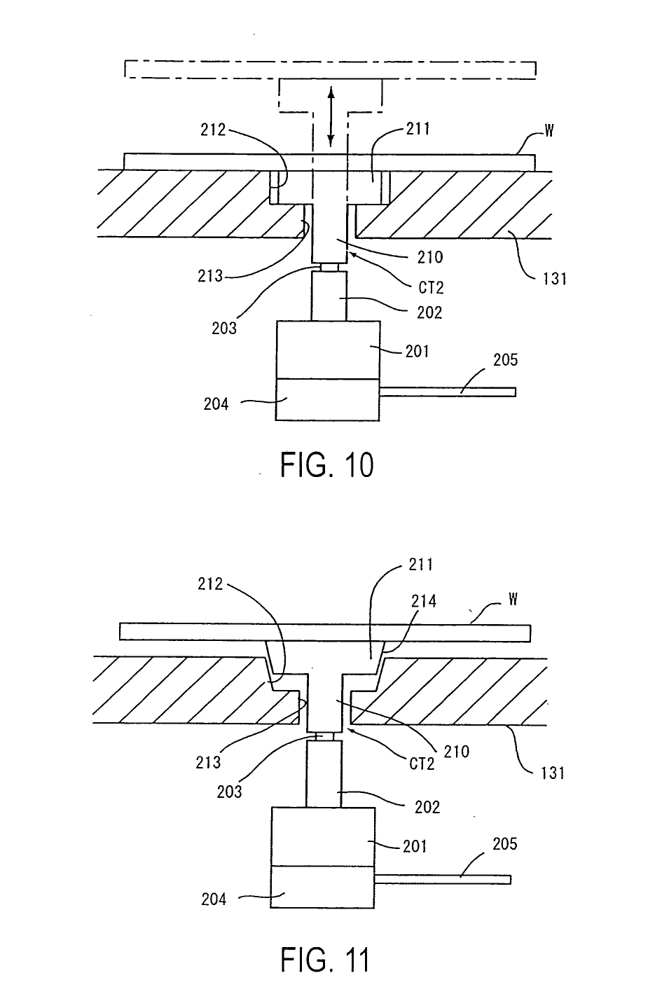

The above-mentioned cooling unit 130 and the improved examples (first and second improved examples) show examples in which the center table that vertically moves the wafer W is used and the three pin members 132 are provided. However, as shown in FIG. 10, as a center table, there is a case that a center table CT2 is used, which has an umbrella-shaped center pin that is arranged so as to go through the center portion of the cool plate 131. With respect to the center table CT2, at the tip portion of the support portion 210 that is formed to be a substantially cylindrical shape, a substantially cylinder-shaped holding portion 211 whose diameter is set to be larger than that of the support portion 210 is integrally formed so that the center axes are matched. On the top surface of the holding portion 211, a plurality of adsorption holes (here, three holes) (undepicted) that attract the wafer W are arranged, which defines a wafer holding surface. In the portion of the center portion of the cool plate 131 corresponding to the center table CT2, a concave portion 212 is formed, which has a shape substantially similar to the holding portion 211 and is slightly larger so that the holding portion 211 can be inserted. In the center portion of the concave portion 212, a throughhole 213 is formed, through which the support portion 210 is inserted.

Even when the center table CT2 is used, in the center portion of the cool plate 131, the concave portion 212 is formed, which houses the holding portion 211 of the center table CT2. Thus, when the wafer W is mounted, the cooling effect of the cool plate 131 may not sufficiently affect the portion corresponding to the concave portion 212, and the temperature distribution may be generated over the wafer W.

Thus, in a third improved example of this embodiment, in a state in which the center table CT2 is lowered, the lower surface of the holding portion 211 of the center table CT2 contacts the bottom surface of the concave portion 212 of the cool plate 131. Additionally, the top surface (wafer holding surface) of the holding portion 211 matches the wafer mounting surface of the cool plate 131. By having such a structure, the holding portion 211 is cooled by the cool plate 131. Through the holding portion 211, the center portion corresponding to the wafer W mounted on the cool plate 131 can be cooled in the same manner as other portions to be cooled by the cool plate 131, which suppresses a temperature distribution from being generated over the wafer W.

Furthermore, as a fourth improved example of this embodiment, as shown in FIG. 11, the holding portion 211 of the center table CT2 is formed to be an inverted conical shape so as to correspond to the concave portion 212 of the cool plate 131, which forms an amphitheater shape. Thus, not only the lower surface of the holding portion 211 but also a side surface 214 can contact the side surface of the amphitheater-shaped concave portion 212 of the cool plate 131, so the cooling effect of the cool plate 131 more efficiently affects the portion corresponding to the wafer W via the holding portion 211.

Additionally, as a shape of the holding portion of the center table, for example, a plurality of arm members (for example, three arm members) are arranged in a petal shape (radial shape), which have adsorption ports, respectively. Alternatively, there are cases that other structures may be used. However, in such a case, if part of the holding portion contacts the cool plate 131 so as to match the concave portion 212 formed in the cool plate 131 in the shape of the holding portion, the same effects can be accomplished.

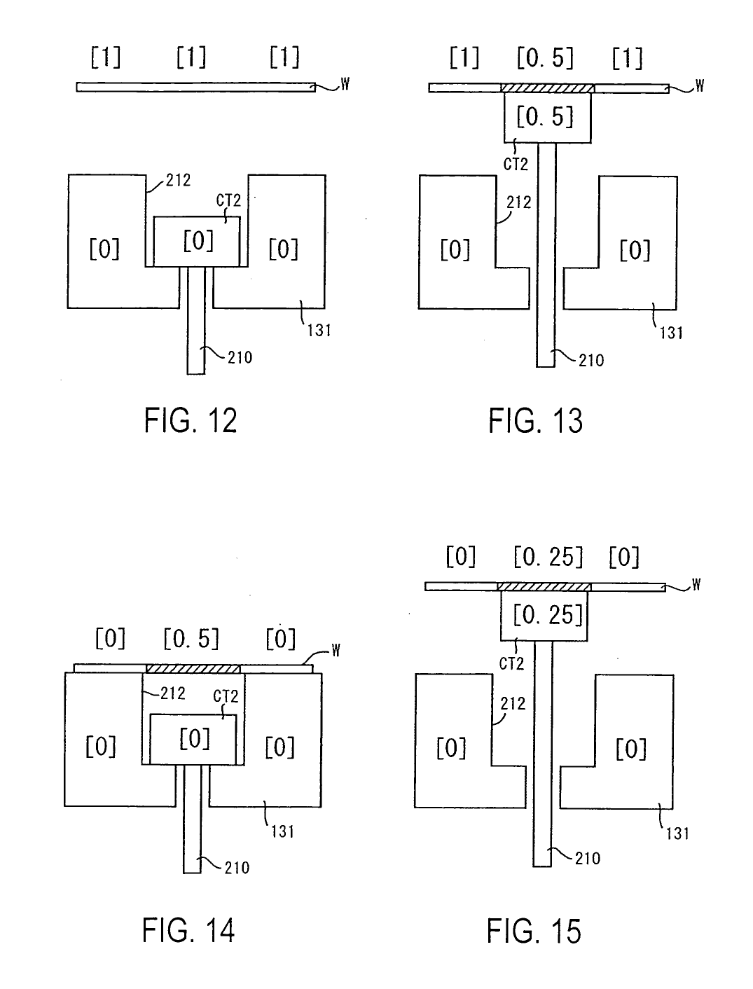

In the third and fourth improved examples shown in FIGS. 10 and 11, respectively, when the Z direction of the center table CT2 is positioned, if it is not easy to match the wafer holding surface of the center table CT2 with the wafer mounting surface of the cool plate 131, a method can used that uses the following procedure (two-step cooling method). This will be explained with reference to FIGS. 12-15. Furthermore, in these figures, [1], [0], [0.5], and [0.25] schematically show the relative temperatures of the respective parts. [0] shows the temperature of the cool plate 131 or a temperature substantially equal to this temperature. [1] shows the temperature of the wafer W to be cooled (that is, to be mounted on the cool plate 131) or a temperature substantially equal to this. [0.5] and [0.25] show intermediate temperatures.

Furthermore, as shown in FIG. 12, before the wafer W is received by the center table CT2, the center table CT2 contacts the concave portion 212 of the cool plate 131 and is cooled. Thus, the center table CT2 is cooled by the cool plate 131, and the temperature of the center table CT2 becomes a temperature [0] substantially equal to the temperature of the cool plate 131. Then, as shown in FIG. 13, the center table CT2 is lifted, the wafer W is received, and the center table CT2 is lowered. As shown in FIG. 14, the wafer W is transferred to the mounting surface of the cool plate 131 (the wafer W is separated from CT2).

During the period in which the center table CT2 holds the wafer W (the period starting from when the center table CT2 receives the wafer W and continuing while the lowering operation is being performed), the center portion of the wafer W is cooled by the center table CT2 that has been cooled in advance (first step of cooling by the center table CT2). According to this first step of cooling, the center portion of the wafer W (the portion that contacts the center table CT2 and the portion in the vicinity of that portion, the portion with diagonal lines in FIGS. 13-15) is cooled by heat exchange with the center table CT2. The center portion of the wafer W and the temperature of the center table CT2 become the intermediate temperature [0.5] between the temperature [0] of the center table CT2 before heat exchange and the temperature [1] before the wafer W is cooled.

Next, as shown in FIG. 14, a peripheral portion (other than the center portion) of the wafer W is cooled on the cool plate 131 which has been transferred. Thus, the peripheral portion of the wafer W becomes substantially the same temperature as temperature [0] of the cool plate 131. The center portion of the wafer W remains the intermediate temperature [0.5]. Furthermore, during this time, the center table CT2 again contacts the concave portion 212 to cool the center table CT2 itself. Thus, the center table CT2 is again cooled by heat exchange with the cool plate 131 and becomes substantially the same temperature [0] as the temperature of the cool plate 131.

Next, as shown in FIG. 15, in order to transfer the wafer W, in which the cooling operation of the peripheral portion of the wafer W has been completed, to another location, the center table CT2 is lifted, the wafer W is vacuum-held and lifted, and the wafer W is carried to a position to be transferred. During the period in which the center table CT2 holds the wafer W (the period starting from when CT2 receives the wafer W and continuing while the lifting operation is being performed, and continuing while the wafer W is held in the lifted position), the center portion of the wafer W is cooled by the center table CT2 which has been cooled in advance (a second step of cooling by the center table CT2).

By this second step of cooling, the center portion of the wafer W is cooled by heat exchange with the center table CT2. The center portion of the wafer W and the center table CT2 become the intermediate temperature [0.25] between the temperature [0] of the center table CT2 before heat exchange and the temperature [0.5] of the center portion of the wafer W. Thus, by having a cooling operation by the center table CT2 at two different times, even if the above-mentioned circumstance occurs, the wafer W can be evenly cooled.

Furthermore, the intermediate temperature [0.5] shown in the figures simply means the temperature between the temperature [1] and the temperature [0]. The temperature [0.25] simply means the temperature between the temperature [0.5] and the temperature [0]. The numerical values are conceptual and do not denote any strict values. In addition, as shown in FIG. 15, the center portion of the wafer W is the temperature [0.25] and does not strictly match the temperature [0] of the peripheral portion. However, the temperature of the center portion of the wafer W becomes a temperature corresponding to a ratio of the heat capacities of the center portion of the wafer W and the center table CT2. Thus, by appropriately setting a specific heat and a mass of the center table CT2 to increase the heat capacity, the temperature of the center portion of the wafer W can be made to approach the temperature of the peripheral portion.

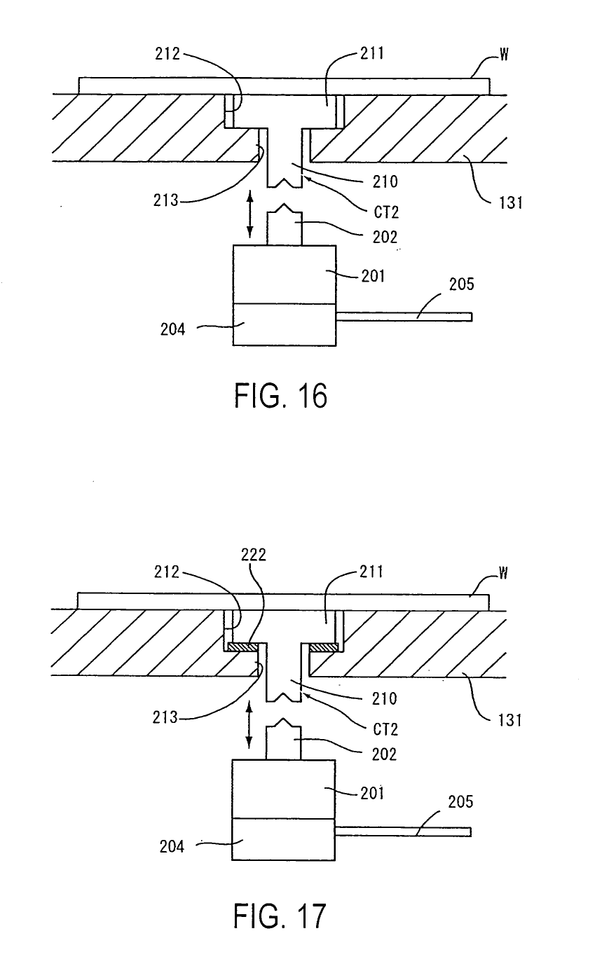

Furthermore, according to the structure shown in FIG. 5, in a coupling portion between the support portion 210 of the center table CT2 and the actuating shaft 202 of the drive portion 201 constituted by, for example, a motor (for example, a voice coil motor), etc., the adiabatic member 203 is arranged, which suppresses the heat of the drive portion 201 from being transmitted to the center table CT2 via the actuating shaft 202. However, there is a concern that because of heat transmittance, the temperature of the holding portion 211 of the center table will not accurately match the temperature of the cool plate 131, or that heat will be transmitted to the cool plate 131 side and that a temperature distribution may be generated over the wafer W. In this case, as a fifth improved example of this embodiment, as shown in FIG. 16, in a state in which the center table CT2 is lowered, a structure may be used that separates the center table CT2 (support portion 210) and the actuating shaft 202 of the drive portion 201 at the coupling portion. By so doing, other than at the times when the center table CT2 is lifted, heat through the actuating shaft 202 of the drive portion 201 may be further suppressed from being transmitted to the center table CT2, and the wafer W can be more appropriately cooled.

Additionally, a coupling mechanism, such as a kinematic coupling, is used for the coupling portion of the support portion 210 of the center table CT2 and the actuating shaft 202 of the drive portion 201. In addition, when the center table CT2 is separated from the drive portion 201, the weight of the center table CT2 may be used to cause the holding portion 211 of the center table CT2 to contact the cool plate 131. However, by arranging an urging member, such as a spring, that downwardly urges the center table CT2, the center table CT2 can more reliably be made to contact the cool plate 131.

Furthermore, by arranging such an urging member in a relationship with the actuating shaft 202 of the drive portion 201 so as to urge in a direction in which the two (the center table CT2 and the actuating shaft 202) are pulled together, at the time of separation, the center table CT2 appropriately contacts the cool plate 131. At the time of coupling, the support portion 210 of the center table CT2 is appropriately coupled to the actuating shaft 202 of the drive portion 201.

Additionally, as a sixth improved example of this embodiment, as shown in FIG. 17, an elastic member 222 formed of a rubber, etc. with high heat conductivity may be arranged at the bottom surface of the concave portion 212 of the cool plate 131. By so doing, the lower surface of the holding portion 211 of the center table CT2 contacts the lower surface of the concave portion 212 of the cool plate 131 via the elastic member 222. The center table CT2 can be sufficiently cooled by the cool plate 131. Additionally, because of the elasticity of the elastic member 222, the tip surface (wafer holding surface) of the center table CT2 is on the same plane as the surface of the cool plate 131. The wafer W is appropriately cooled via the cool plate 131 and the center table CT2 contacting the rear surface of the wafer W. The temperature irregularity of the portion contacting the cool plate 131 of the wafer W and the portion contacting the holding portion 211 can be reduced.

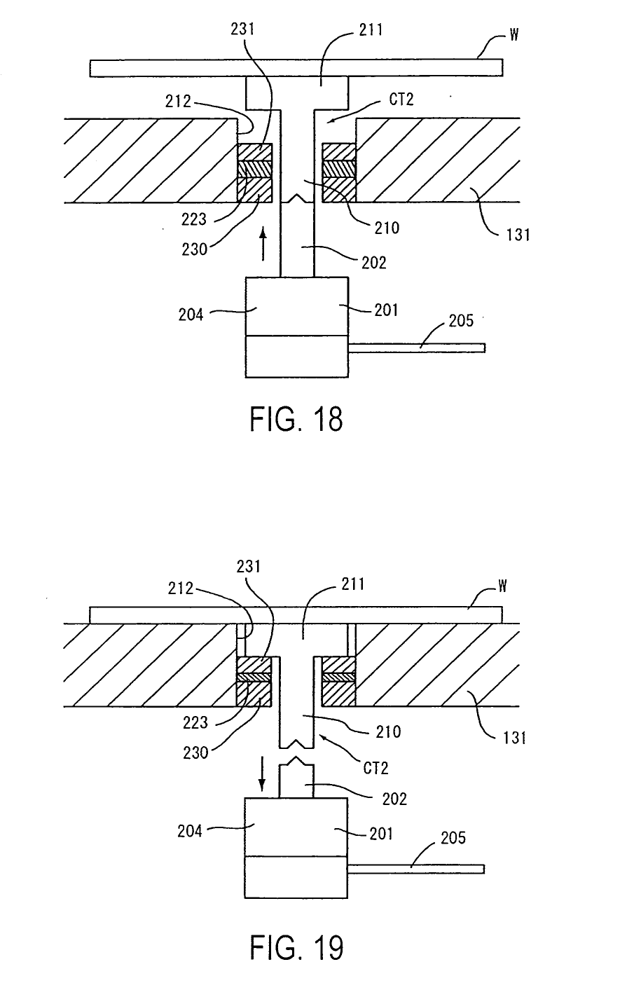

Additionally, as a seventh improved example of this embodiment, a structure shown in FIGS. 18 and 19 also can be used. In this seventh improved example, a throughhole is formed in the center portion of the cool plate 131. A first sub cool plate 230 separate from the cool plate 131 is arranged on the lower portion of the throughhole, and a concave portion 212 is formed. On the top portion of the first sub cool plate 230, in the same manner as the elastic member 222 of FIG. 17, an elastic member 223 formed of a rubber, etc. with high heat conductivity is arranged. Furthermore, on the elastic member 223, a second sub cool plate 231 separate from the cool plate 131 is arranged. The second sub cool plate 231 is supported by the elastic member 223 so as to be vertically slidable inside of the concave portion 212 of the cool plate 131 according to expansion or contraction of the elastic member 223. The first sub cool plate 230 and the second sub cool plate 231 are provided with the same cooling mechanism as in the cool plate 131.

Thus, when the center table CT2 is lowered from the state in which the center table CT2 is lifted as shown in FIG. 18 to the state shown in FIG. 19, the elastic member 223 is appropriately compressed by the weight of the wafer W, etc., and the top surface (wafer holding surface) of the holding portion 211 of the center table CT2 is made to be on the same plane as the wafer mounting surface of the cool plate 131. As a result, the lower surface of the holding portion 211 of the center table CT2 contacts the upper surface of the second sub cool plate 231, and the center table CT2 can be appropriately cooled. At the same time, as the center table CT2 appropriately contacts the wafer W, the wafer W can be evenly cooled. Additionally, compared to the above-mentioned sixth improved example, the center table contacts a cool plate (second sub cool plate) without going through the elastic member, so the temperature adjustment efficiency can be improved.

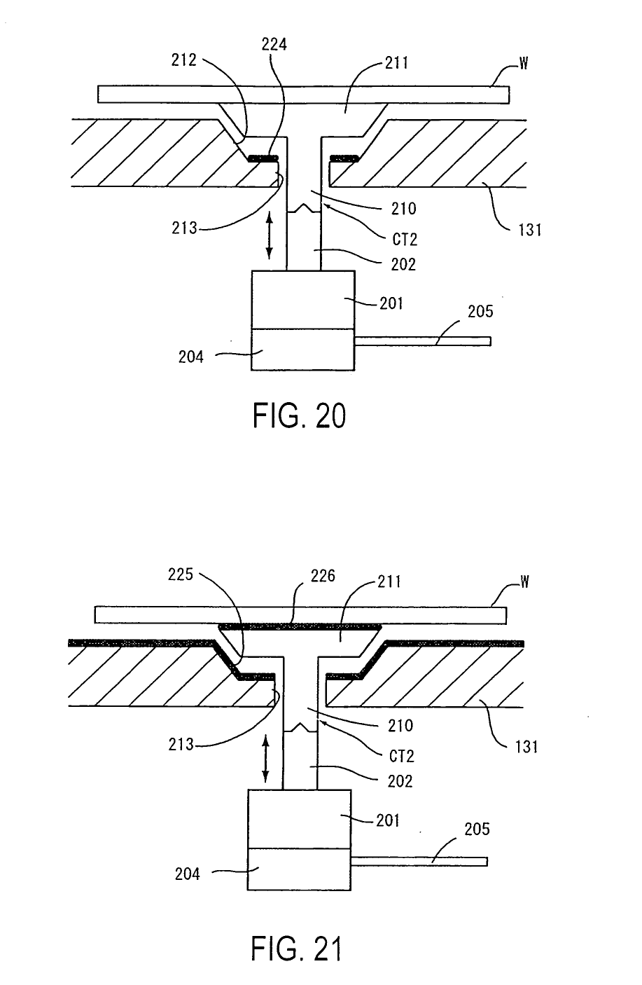

Furthermore, as an eighth improved example of this embodiment, as shown in FIG. 20, on the bottom surface of the amphitheater-shaped concave portion 212 of the cool plate 131, an elastic member 224 formed of a rubber, etc. with high heat conductivity may be arranged. By so doing, the top surface (wafer holding surface) of the holding member 211 of the center table CT2 can be made to be on the same plane as the wafer mounting surface of the cool plate 131. At the same time, the lower surface of the holding portion 211 of the center table CT2 contacts the bottom surface of the amphitheater-shaped concave portion 212 of the cool plate 131 via the elastic member 224, without a gap, and the cooling efficiency can be improved. Additionally, although not depicted in the figure, the same elastic member as the elastic member 224 also can be arranged on the side surface of the amphitheater-shaped concave portion 212. By so doing, the holding portion 211 is cooled by the cool plate 131 also via the side surface, and the cooling efficiency also can be improved.

In addition, as a ninth improved example of this embodiment, as shown in FIG. 21, elastic members 225, 226 formed of a rubber, etc. with high heat conductivity also can be arranged on the bottom surface and the side surface of the amphitheater-shaped concave portion 212 of the cool plate 131, the top surface (wafer mounting surface) of the cool plate 131, and the top surface (wafer holding surface) of the holding portion 211. By so doing, the lower surface and the side surface of the holding portion 211 of the center table CT2 contact the bottom surface and the side surface of the amphitheater-shaped concave portion 212 of the cool plate 131 via the elastic member 225. Additionally, the wafer W contacts the top surface of the cool plate 131 and the top surface of the holding portion 211, so the cooling efficiency can be improved. The respective portions positioned on the bottom surface of the concave portion 212 of the elastic member 225, the side surface thereof, and the top surface of the cool plate 131 are integrally formed in this example. However, it is also acceptable for one portion or all of the portions to be separated from each other. Furthermore, it is also acceptable to use only one of the elastic members 225 or 226.

Arranging elastic members on the top surface of the cool plate 131 and/or the top surface of the holding portion 211 as described in the ninth improved example also can be applied to the above-mentioned embodiments and the respective improved examples (first through eighth improved examples). Furthermore, using the elastic members and the second sub cool plate as described in the above-mentioned seventh improved example also can be applied to the above-mentioned embodiments and the respective improved examples (first through sixth, eighth, and ninth improved examples). Additionally, in the above-mentioned respective improved examples, by causing air whose temperature has been adjusted to flow into a gap between the cool plate 131 and the holding portion 211, the temperature difference between the cool plate 131 and the holding portion 211 can be minimized.

According to the above-mentioned respective improved examples, the temperature irregularity between the portion contacting the center table (three pins or center pin) of the wafer W and the portion contacting the cool plate 131 can be reduced, and the temperature of the wafer W can be evenly controlled. In addition, part of the center table contacts the cool plate 131, and the center table is cooled. Therefore, for example, compared to the structure in which a temperature adjustment mechanism is incorporated into a center table itself, the temperature of the wafer W can be evenly controlled by a simplified structure. However, compared to the above-mentioned respective improved examples, the structure may become complex, but by incorporating a temperature control mechanism into the center table CT2, the temperature of the center table CT2 may be directly controlled.

Furthermore, the structure of the cool plate 131 and center table (three pins or center pin) and the cooling operation disclosed in FIGS. 7-21 and explained above may be applied to the above-mentioned wafer holder WH (wafer stage WST) and the center table CT1. This type of structure and operation may be used in the wafer holder WH, so the temperature of the wafer also may be suitably controlled on the wafer holder.

Next, an operation of transferring a wafer W by the wafer transfer apparatus WL is explained. When the wafer W is processed, which is housed within the wafer carrier WC carried to a FOUP (FOUP) position P1, the wafer W within the wafer carrier WC is taken out by the load robot 120, is carried to the position P2 at which the transfer table unit 110 is arranged, and is mounted on the upper table 111.

Furthermore, when a wafer W transferred in-line from the resist coater is to be processed, the wafer W is mounted on the upper table 111 by the transfer apparatus of the resist coater. In the transfer table unit 110, the first prealignment portion is arranged. Here, first prealignient is performed. The first prealignment detects a notch position and decentering of the wafer W, and is performed so as to correct the position and the rotation. As the upper table is lowered with respect to the turntable 112 waiting in a transfer position (lifted position), the wafer W mounted on the upper table 111 is transferred onto the turntable 112 and is vacuum-attracted by the turntable 112 by the adsorption function of the turntable 112.

Next, the turntable 112 is rotated, and the outline of the wafer W and the notch portion (or orientation flat portion) are detected by a line CCD sensor S11. Shifting of the wafer W in the rotational direction is corrected by stopping the rotation of the turntable 112 at a position at which the shift is canceled. The shift of the center position is resolved so as to correct the position of the hand portion 124 of the load robot 120 when the wafer W is taken out by the load robot 120. The wafer W on which the first prealignment has been completed is taken out by the load robot 120, is carried to the position P3 at which the wafer is transferred to the cleaning unit 130, and is carried onto the three pin members 132 (hereafter referred to as “center table 132”) that have been lifted.

Next, second prealignment is performed by the second prealignient portion arranged in the cleaning unit 130. That is, the illumination light is irradiated by the illumination devices EL21, EL22, EL23 arranged in the cleaning unit 130. At the same time, three predetermined locations of the periphery of the wafer W are imaged by the image pick-up devices S21, S22, S23. Based on the imaging result, an error with respect to a predetermined reference of the center position and the rotation position of the wafer W is detected. This error is corrected as the micro-adjusting table 207 is driven, which micro-adjusts the position and the rotation of the cleaning unit 130.

As the center table 132 is lowered, the wafer W on which second prealignment has been completed is mounted on the top surface of the cool plate 131 and is mounted on the cool plate 131 for a predetermined time. Thus, the temperature of the wafer W is controlled so as to be even over the entire surface of the wafer.

When cooling of the wafer W is completed, in a state in which the slider arm 143 of the load slider 140 is held at a predetermined waiting position between the positions P3 and P5, after the center table 132 is lifted, the slider arm 143 is moved forward (moved in the +Y axis direction) to a predetermined transfer position and stopped. Then, in a state in which adsorption holding by the center table 132 is released, as the center table 132 is lowered, the wafer W whose temperature has been controlled (cooled) is transferred to the slider arm 143. Next, by the load slider 140, the wafer W is transferred in the +Y axis direction and is carried to the position P4 at which the wafer W is transferred to the wafer stage WST.

In the position P4 at which the wafer W is transferred between the wafer stage WST and the slider arm 143, a third prealignment portion is arranged, which is constituted by the image pick-up devices S1, S2, S3 supported by the main body column MCL of the exposure apparatus EX and the illumination devices EL1, EL2, EL3 arranged in the arm slider 143. In a state in which the wafer W is held in the slider arm 143, third prealignment is performed.

Next, after micro-movement within the XY plane of the wafer stage WST and micro-rotation about the Z axis are performed in order to cancel an error, with respect to a predetermined reference, of the center position and the rotation position of the wafer W measured by the third prealignment, lifting of the center table CT1 begins. At the same time, adsorption of the wafer W by the slider arm 143 is released. Next, lifting of the center table CT1 is stopped in a state in which the tip surface of the center table CT1 is positioned slightly above the upper surface of the slider arm 143 (the upper surface of the ports of the adsorption grooves 146a, 146b), and adsorption holding of the wafer W by the center table CT1 is performed.

When adsorption holding is performed, fourth prealignment is performed, and errors with respect to a predetermined reference of the center position and the rotation position of the wafer W are detected. The errors of the center position of the wafer W measured by the fourth prealignment and the rotation errors are canceled by micro-movement (that is, addition to a target value of the stage movement) and micro-rotation of the wafer stage WST. Furthermore, the rotational error of the wafer W may be canceled by micro-rotation of the reticle R of the time of exposure. Here, if the reticle stage can be not only rotated but also XY micro-moved, and the error (center position error, rotation error) measured by the fourth prealignment is an amount that can be corrected by XY movement and rotational movement of the reticle stage, correction also may be performed by the reticle stage only.

Next, as the slider arm 143 is withdrawn, the center table CT1 is lowered, adsorption holding of the wafer W by the center table CT1 is appropriately released, and the center table CT1 is further lowered, the wafer W is moved onto the wafer stage WST.

Next, after the wafer W is vacuum-held by the wafer holder WH on the wafer stage WST and is transferred to a predetermined exposure position by the wafer stage WST, and search alignment and fine alignment are performed, which measure a mark on the wafer W by the alignment sensor ALG, an image of a pattern of the reticle R is exposed and transferred onto the wafer W by the exposure apparatus EX. When the exposure processing for the wafer W is completed, the wafer stage WST is moved and is again positioned in the transfer position P3.

The wafer W on which the exposure processing has been completed is transferred to the unload arm 153 of the unload slider 150 via the center table CT1. Next, the wafer W is transferred to the position P5 at which the wafer W is transferred to the unload robot 160 by the unload slider 150, and is transferred to the hand portion 164 of the unload robot 160. The wafer W transferred to the hand portion 164 of the unload robot 160 is carried to the position P6. If a water removable unit is arranged in the position P6, after water on the wafer W is removed, the wafer W is transferred to the hand portion 124 of the load robot 120, and is carried to the lower table that transfers the wafer W to the inside of the wafer carrier WC arranged in the FOUP position P1 or the developer of the transfer table unit 110 at the position P2 by the load robot 120.

According to the above-mentioned embodiment, in the cooling unit 130, the cool plate 131 that cools the wafer W, on which the wafer W is mounted, is supported above the first adiabatic plate 135 via the plurality of adiabatic members 134 and the first gap 134a. At the same time, the cool plate 131 is supported above the second adiabatic plate 137 via the pipe arrangement 136 through which a coolant flows and the second gap 136a. Thus, the heat to be transmitted to the cool plate 131 from the drive portion casing 139 that houses a heat generating body (drive portion 201, etc.) can be effectively shielded. Furthermore, in the above-mentioned embodiment, the second adiabatic plate 137 is further supported above the drive portion casing 139 via the adiabatic members 138 and the third gap 138a, so the heat to be transmitted to the cool plate 131 can be further effectively shielded.

Additionally, as air surrounding the cool plate 131 is emitted by the exhaust fan 206 via the first gap 134a, the second gap 136a, the third gap 138a, and the inside of the drive portion casing 139. Thus, the heat to be transmitted to the cool plate 131 can be further effectively shielded. Furthermore, by arranging the illumination devices CL21, CL22, CL23 on the cleaning unit 130 side, the wafer W is imaged by the image pick-up devices S21, S22, S23, using transmitted illumination. Thus, compared to an apparatus using reflected illumination, the position of the wafer W and the rotational error can be more accurately detected. Additionally, an organic EL light emitting body is used as the illumination devices EL21, EL22, EL23. These light emitting bodies have a small heat generation amount. At the same time, these are arranged within the drive portion casing 139, so there is hardly any heat effect on the cool plate 131 because of the heat generation of the illumination devices EL21, EL22, EL23.

Furthermore, in the load arm unit 140, the slider arm 143 is mounted to a movable element of the linear motor LM via the heat sink 147. Thus, transmission of the heat from the linear motor LM as a heat generating body to the slider arm 143 can be effectively shielded. The wafer W in which the temperature is appropriately cooled by the cleaning unit 130 can be carried to the position P4 at which the wafer W is transferred to the wafer stage WST of the exposure apparatus EX in a state in which the temperature is maintained. Thus, the wafer W can be supplied to the exposure apparatus EX at a constantly appropriate temperature. Therefore, exposure accuracy such as overlay accuracy of a pattern can be improved, and a micro-device, etc. with high performance capability, high quality, and high reliability can be manufactured.

In addition, a semiconductor element is manufactured as a device, based on a step performing device function/performance capability design, a step of manufacturing a reticle based on the design step, a step of manufacturing a wafer from a silicon material, a step of exposing and transferring a pattern of the reticle to a wafer by an exposure apparatus, etc. of the above-mentioned embodiments, a device assembly step (including a dicing process, a bonding process, and a packaging process), a testing step, etc.

In order to facilitate understanding of this invention, the above-explained embodiments are described. They are not intended to limit this invention. Therefore, the respective elements disclosed in the above-mentioned embodiments, including all design modifications and equivalents thereof, are within the technical scope of this invention. For example, in the above-mentioned embodiments, a case was explained in which this invention was applied to a liquid immersion type step-and-scan type exposure apparatus. However, this invention also can be applied to a step-and-repeat type exposure apparatus, mirror projection type exposure apparatus, proximity type exposure apparatus, contact type exposure apparatus, etc.

Furthermore, this invention can be applied to not only a semiconductor element and a liquid crystal display element, but also to an exposure apparatus used for manufacturing a plasma display, a thin film magnetic head, an image pick-up element (CCD, etc.), a micro machine, a DNA chip, etc., and an exposure apparatus for manufacturing a reticle or a mask. That is, this invention can be applied regardless of the exposure type or usage of exposure apparatus. In addition, in the above-mentioned embodiments, a transfer apparatus that carries a substrate such as a wafer and a temperature control apparatus of an exposure apparatus were explained. However, this invention is not limited to this, but can be applied to any type of object transfer apparatus that carries an object, and any type of object temperature control apparatus by which temperature of an object is controlled.

Furthermore, in the above-mentioned embodiments, the temperature control of the wafer by the cool plate was explained, but this invention is not limited to this. For example, as disclosed in US Patent Application Publication 2006/0033892, this invention also can be applied to a structure in which the temperature of the substrate holder that holds a substrate is adjusted.

Furthermore, to the extent that the law permits, all the publications and U.S. Patent disclosures used with respect to exposure apparatus, etc. cited in the above-mentioned respective embodiments and modified examples are incorporated by reference herein in their entireties.

1. An object transfer apparatus having a holding member that holds an object and a drive device having a movable element to which the holding member is fixed, and that integrally moves with the holding member, comprising:
a holding member temperature control apparatus that is provided between the movable element and the holding member and adjusts the holding member to a predetermined temperature.

2. The object transfer apparatus according to claim 1,
wherein the holding member temperature control apparatus is a heat sink through which temperature-controlled fluid flows.

3. The object transfer apparatus according to claim 1, further comprising:
an adiabatic member provided between the holding member temperature control apparatus and the movable element.

4. The object transfer apparatus according to claim 1,
wherein the object is received from an object temperature control apparatus that controls the object to a predetermined temperature, and the object is transferred to a predetermined transfer position with respect to a device to which the object is transferred.

5. The object transfer apparatus according to claim 1,
wherein the holding member temperature control apparatus includes a Peltier element.

6. An exposure apparatus including the object transfer apparatus according to claim 1,
wherein a pattern of a mask is exposed and transferred to an object mounted on a movable stage.

7. The exposure apparatus according to claim 6,
wherein the object transfer apparatus transfers a substrate to be exposed by the exposure apparatus to the inside of the exposure apparatus.

8. An object temperature control apparatus that controls an object to a predetermined temperature, comprising:
a temperature adjustment plate, that has a mounting surface on which the object is mounted, and through which temperature-controlled fluid flows;
a first adiabatic plate that supports a plurality of first adiabatic support members and the temperature adjustment plate via a first gap formed between the support members, and that is arranged opposite to a rear surface of the temperature adjustment plate; and
a second adiabatic plate that supports a temperature adjustment pipe arrangement, through which a temperature-controlled fluid flows, and the first adiabatic plate via a predetermined second gap, and that is arranged opposite to the rear surface of the first adiabatic plate,
wherein on a casing in which a heat generating body is housed, the temperature adjustment plate is arranged via the second adiabatic plate, the temperature adjustment pipe arrangement, the second gap, the first adiabatic plate, the first adiabatic support member, and the first gap.

9. The object temperature control apparatus according to claim 8,
wherein on the casing, via a plurality of second adiabatic support members and a third gap formed between the support members, the second adiabatic plates are arranged facing each other.

10. The object temperature control apparatus according to claim 9, further comprising:
a gas passage and an exhaust device to which gas surrounding the temperature adjustment plate is exhausted to the outside of the casing external portion via the first, second, and third gaps, and the inside of the casing.

11. An object temperature control apparatus, comprising:
a temperature adjustment plate that controls the temperature of an object mounted on a mounting surface to a predetermined temperature; and
a lift member that holds and lifts the object between (i) a predetermined transfer position separated from the mounting surface and (ii) the mounting surface in order to transfer the object with respect to the mounting surface,
wherein part of a surface of a holding portion of the lift member that holds the object contacts the temperature adjustment plate in a state in which the object is lowered so as to be mounted on the mounting surface.

12. The object temperature control apparatus according to claim 11,
wherein the holding portion of the lift member that holds the object is formed so as to be separated from a drive device that lifts the lift member, and is separated from the drive device in a state in which the lift member is lowered in order to mount the object on the mounting surface and in a state in which the holding member contacts the temperature adjustment plate.

13. The object temperature control apparatus according to claim 11, further comprising:
at least one illumination device that illuminates part of the periphery of the object from the temperature adjustment plate side.

14. The object temperature control apparatus according to claim 13,
wherein the illumination device supplies illumination light with respect to a detection device arranged opposite to the mounting surface in order to detect part of the periphery of the object.

15. The object temperature control apparatus according to claim 13,
wherein the illumination device is provided with an organic EL light emitting body.

16. An exposure apparatus that exposes and transfers a pattern of a mask to an object mounted on a movable stage, the exposure apparatus comprising the object temperature control apparatus according to claim 11.

17. An object transfer apparatus having a lift member that holds and lifts an object between (i) a predetermined transfer position away from a mounting surface and (ii) the mounting surface in order to transfer the object with respect to the mounting surface, comprising:
a temperature control apparatus that controls the temperature of the lift member to a predetermined temperature.

18. The object transfer apparatus according to claim 17,
wherein when the lift member is lowered, the holding surface of the lift member that holds the object is made to be on the same plane as the mounting surface.

19. The object transfer apparatus according to claim 17,
wherein the holding portion of the lift member that holds the object is formed so as to be separated from a drive device that lifts the lift member, and is separated from the drive device in a state in which the lift member is lowered in order to mount the object on the mounting surface and in a state in which the holding member contacts a temperature adjustment plate.

20. An object transfer apparatus, comprising:
a temperature adjustment plate that controls the temperature of an object mounted on a mounting surface to a predetermined temperature; and
a lift member that holds and lifts the object between (i) a predetermined transfer position away from the mounting surface and (ii) the mounting surface in order to transfer the object with respect to the mounting surface,
wherein the temperature of the lift member is adjusted by the temperature adjustment plate.

21. The object transfer apparatus according to claim 20,
wherein when the lift member is lowered, the holding surface of the lift member that holds the object is made to be on the same plane as the mounting surface.

22. The object transfer apparatus according to claim 20,
wherein the holding portion of the lift member that holds the object is formed so as to be separated from a drive device that lifts the lift member, and is separated from the drive device in a state in which the lift member is lowered in order to mount the object on the mounting surface and in a state in which the holding member contacts the temperature adjustment plate.

23. An object transfer apparatus having a lift member that holds and lifts an object between (i) a predetermined transfer position away from a mounting surface and (ii) the mounting surface in order to transfer the object with respect to the mounting surface, wherein:
the lift member controls the temperature of the object.

24. The object transfer apparatus according to claim 23,
wherein when the lift member is lowered, the holding surface of the lift member that holds the object is made to be on the same plane as the mounting surface.

25. The object transfer apparatus according to claim 23,
wherein a holding portion of the lift member that holds the object is formed so as to be separated from a drive device that lifts the lift member, and is separated from the drive device in a state in which the lift member is lowered in order to mount the object on the mounting surface and in a state in which the holding member contacts a temperature adjustment plate.

26. An object transfer method in which a lift member holds and lifts an object between (i) a predetermined transfer position away from a mounting surface and (ii) the mounting surface in order to transfer the object with respect to the mounting surface, comprising the step of:
controlling the temperature of the lift member to a predetermined temperature.

27. The object transfer method according to claim 26,
wherein when the lift member is lowered, the holding surface of the lift member that holds the object is made to be on the same plane as the mounting surface.

28. The object transfer method according to claim 26, further comprising the step of:
separating a holding portion that holds the object of the lift member from a drive device that lifts the lift member in a state in which the lift member is lowered in order to mount the object on the mounting surface and in a state in which the holding member contacts the temperature adjustment plate.

29. A method of manufacturing a micro device, comprising:
a transfer step that transfers an object, using the object transfer method according to claim 26;
an exposure step that exposes and transfers a predetermined pattern onto the object; and
a developing step that develops the object that has been exposed by the exposure step.

30. An object transfer method in which an object is transferred by a lift member that holds and lifts the object between (i) a predetermined transfer position away from a mounting surface and (ii) the mounting surface in order to transfer the object with respect to the mounting surface of a temperature adjustment plate that controls the temperature of the object mounted on the mounting surface to a predetermined temperature; comprising the step of:
controlling the temperature of the lift member by the temperature adjustment plate.

31. The object transfer method according to claim 30,
wherein when the lift member is lowered, a holding surface of the lift member that holds the object is made to be on the same plane as the mounting surface.

32. The object transfer method according to claim 30, further comprising the step of:
separating a holding portion that holds the object of the lift member from a drive device that lifts the lift member in a state in which the lift member is lowered in order to mount the object on the mounting surface and in a state in which the holding member contacts the temperature adjustment plate.

33. A method of manufacturing a micro device, comprising:
a transfer step that transfers an object, using the object transfer method according to claim 30;
an exposure step that exposes and transfers a predetermined pattern onto the object; and
a developing step that develops the object that has been exposed by the exposure step.

34. An object transfer method in which an object is transferred by a lift member that holds and lifts an object between (i) a predetermined transfer position away from a mounting surface and (ii) the mounting surface in order to transfer the object with respect to the mounting surface, comprising the step of:
controlling the temperature of the object to a predetermined temperature via the lift member.

35. The object transfer method according to claim 34,
wherein when the lift member is lowered, a holding surface of the lift member that holds the object is made to be on the same plane as the mounting surface.

36. The object transfer method according to claim 34, further comprising the step of:
separating a holding portion that holds the object of the lift member from a drive device that lifts the lift member in a state in which the lift member is lowered in order to mount the object on the mounting surface and in a state in which the holding member contacts a temperature adjustment plate.

37. A method of manufacturing a micro device, comprising:
a transfer step that transfers an object, using the object transfer method according to claim 34;
an exposure step that exposes and transfers a predetermined pattern onto the object; and
a developing step that develops the object that has been exposed by the exposure step.
